(19) United States
(12) Patent Application Publication
(10) Pub. No.: US 2006/0165927 A1
(43) Pub. Date: Jul. 27, 2006

(54) Retort pouches

(75) Inventors: Shigenobu Harano, Kawasaki-shi (JP); Miho Sagae, Kawasaki-shi (JP); Shinichi Matsumoto, Kawasaki-shi (JP); Mayumi Omori, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/391,265

(22) Filed: Mar. 29, 2006

Related U.S. Application Data
(63) Continuation of application No. PCT/JP04/14331, filed on Sep. 30, 2004.

(30) Foreign Application Priority Data
Sep. 30, 2003 (JP) 2003-339846

(51) Int. Cl. B32B 27/32

(52) U.S. Cl. 428/35.2

(57) ABSTRACT

The present invention provides a retort pouch which is made from a metal laminated film having the multilayer structure of a crystalline polypropylene resin film/an adhesive resin layer including a modified polypropylene/a metal foil/an adhesive layer/an oriented nylon film/an adhesive layer/a polyester film; and the retort pouch wherein a cutout for opening that is opening toward the side border is formed on the upper position of a heat-sealed part leaving some space from the superior border, an opening for pouring the contents is formed on the cut part by cutting the corner between the cutout and the superior border, and the opening is formed by cutting the corner along the line extending from the cutout for opening to the superior border at angles of 20 to 80 degrees to the side border. According to this retort pouch, the pouch is easy to open due to ease of tearing and does not easily lose the shape of the opening.

### TECHNICAL FIELD OF THE INVENTION

The present invention relates to pouches for containing retort foods including fluid products such as liquids, powders and granular materials, and particularly including liquid diets and the like. Especially it relates to standing pouches.

### BACKGROUND OF THE INVENTION

Recent years, standing pouches have been used as a container for storing flowable retort foods such as liquid diets. Such pouches are formed by use of strong laminated films that can maintain their configurations by themselves when contents are stored therein. In addition to the strength, the laminated films are required to have the properties such as retort resistance, the oxygen-barrier ability, and easiness of tearing which is a basis of easy-opening.

As for such laminated films, for example, Japanese Patent Publication (JP Kokoku) No. Hei 1-54191 discloses a process for producing laminates for sealed and sterilized packages which comprises the steps of unifying a film layer of a crystalline polypropylene resin with an aluminum foil or sheet through an adhesive layer; heating and melting once the crystalline polypropylene resin remaining adhered to the aluminum foil and the like, and solidifying the resin by cooling; and then unifying a heat-resistant resin film layer that has a higher melting point than that of the above crystalline polypropylene resin on the side of the aluminum foil and the like through an adhesive layer. Herein, only a polyester film is disclosed as an example of the heat-resistant resin film that has a higher melting point. Further, Japanese Patent Unexamined Publication (JP Kokai) No. Hei 11-321885 discloses a multilayer film comprised of a base material layer 11/an adhesive layer 15/an oriented film layer 12/an adhesive layer 15/a heat sealant layer 14; a multilayer film comprised of a base material layer 11/an adhesive layer 15/an oriented film layer 12/an adhesive layer 15/a barrier layer 13/an adhesive layer 15/a heat sealant layer 14; and a multilayer film comprised of a base material layer 11/an adhesive layer 15/a barrier layer 13/an adhesive layer 15/an oriented film layer 12/an adhesive layer 15/a heat sealant layer 14. Examples of the base material layer 11 include oriented and un-oriented films of polypropylene, polyester, and polyamide resin.

These multilayer films are of the purpose of satisfying contradictory properties such as easy-opening by easiness of tearing and strength of a container for protecting contents. Retort pouches which are further easier to open and have excellent strength have been desired. Especially, since the opening of pouches easily lose its shape when using the above multilayer films and it is inconvenient when transferring contents of the pouches into other containers, it has been desired to have those which do not easily lose the shape of the opening.

[Patent Literature 1] Japanese Patent Publication No. Hei 1-54191, see Claims thereof.

[Patent Literature 2] Japanese Patent Unexamined Publication No. 11-321885, see [0018] and [0019] thereof.

### DISCLOSURE OF THE INVENTION

The object of the present invention is to provide a pouch which is made from a multilayer film that is easy to open due to easiness of tearing and does not easily lose the shape of the opening.

The present invention has been completed based on the findings that the above problems can be more effectively solved, in formation of multilayer films, by including the film formation of three layers consisting of a crystalline polypropylene resin film, an adhesive resin layer including a modified polypropylene, and a metal foil; and making an oriented nylon film intervene between the metal foil and the polyester film.

Namely, the present invention provides a retort pouch which is made from a metal laminated film having a multilayer structure of a crystalline polypropylene resin film/an adhesive resin layer including a modified polypropylene/a metal foil/an adhesive layer/an oriented nylon film/an adhesive layer/a polyester film.

The present invention also provides the retort pouch which is formed by heat-sealing the above metal laminated film so that the crystalline polypropylene resin film becomes inside of the pouch.

The present invention further provides the retort pouch wherein a cutout for opening that is opening toward the side border is formed on the upper position of a heat-sealed part leaving some space from the superior border, and an opening for pouring the contents is formed on the cut part by cutting the corner between the cutout and the superior border; the retort pouch wherein the opening is formed by cutting the corner along the line extending from the cutout for opening to the superior border at angles of 20 to 80 degrees to the side border; and the retort pouch wherein the length of the opening formed by the cutting is set to 15 to 60 mm.

### BRIEF DESCRIPTION OF THE DRAWINGS

FIG. 1 shows a front view of a standing retort pouch.

FIG. 2 shows the other form of a cutout (notch) for opening in the pouch.

FIG. 3 shows the other form of a cutout (notch) for opening in the pouch.

1: pouch
2: heat-sealed part
3: cutout (notch) for opening

### BEST MODE FOR CARRYING OUT THE INVENTION

Examples of the crystalline polypropylene resin films used in the present invention includes a homopolymer type wherein the films are obtained by polymerizing polypropylenes only, a copolymer type wherein they are obtained by copolymerizing ethylenes and the like with propylenes, and a terpolymer type wherein they are obtained by copolymerizing three kinds of propylenes, ethylenes, and butylenes. For example, they include copolymers which can be produced in accordance with the production methods described in Japanese Patent Publication (JP Kokoku) Nos. Sho 44-16668 or Sho 55-8011, such as ethylene propylene block copolymers of which ethylene concentration is 3 to 40 weight % and preferably 5 to 30 weight %, melt flow index (MFI) is 0.1 to 40 g/10 mm (ASTM-D-1238) and preferably 20 g/10 mm or less, and absorbance ratio between 720 cm⁻¹ and 731 cm⁻¹ is 0.5 or larger; and blended compounds with other polyolefin resins containing 50 weight % or more of the above copolymers. The thickness of the crystalline polypropylene resin films can be optional, and it is preferably 30 to 80 μm.

Metal foils used in the present invention are whatever can be easily torn by hands, including forms of metal sheets and metal films. As for metals, aluminum is preferable, that is, an aluminum foil is more preferable. The thickness of the metal foils can be optional as far as they can be easily torn by hands, and it is preferably about 3 to 10 μm.

As for modified polypropylenes in the adhesive resin layer including a modified polypropylene used in the present invention, a carboxylic acid modified polypropylene is preferable and a maleic anhydride modified polypropylene is particularly preferable. In this connection, the adhesive resin layer including a modified polypropylene is preferably in the form of a single layer of a modified polypropylene resin or in the form of a double layer having a modified polypropylene resin layer and an unmodified polypropylene resin layer. Such adhesive resin layer is used so that the modified polypropylene resin layer adheres to the metal foil. The unmodified polypropylene resin includes ordinary polypropylene resins. In the present invention, it is particularly preferable to use the adhesive resin layer in the form of the double layer having the modified polypropylene resin and the unmodified polypropylene resin layer because it is easy to manufacture and excellent in adhesion to both of a crystalline polypropylene film and a metal foil, and a metal laminated film is obtained having the thickness enough to maintain the strength.

The thickness of the adhesive resin layer can be optional as far as it can tightly bond a crystalline polypropylene resin film to a metal foil, and it is preferably about 3 to 30 μm. When using the layer in the form of the double layer having the modified polypropylene resin and the unmodified polypropylene resin layer, it is preferable that the modified polypropylene resin is about 1 to 10 μm and the unmodified polypropylene resin layer is about 9 to 20 μm. Further, corresponding to the production methods, the adhesive resin layer can be added as a film and then welded.

As for polyester films, polyethylene terephthalate and polybutylene terephthalate are preferable. Polyethylene terephthalate is more preferable among them, and it is preferable to use a film thereof having the thickness of about 9 to 20 μm. As for oriented nylon films, it is preferable to stretch 6 nylon or 66 nylon films and to use those having the thickness of about 10 to 30 μm. Thus, when setting an oriented nylon film layer between a polyester film and a metal foil, the strength in forming a standing pouch and its independence are improved. Especially, it is preferable in terms of the easiness in transferring contents into other containers because the opening of a pouch does not easily lose its shape. Further, benefits are obtained such as that holes are not easily made on the side of a container because a standing pouch is not easily torn or damaged on the parts other than a cutout (e.g. notch) for opening the pouch. As for adhesives used for bonding a metal foil and an oriented nylon film, and a polyester film and an oriented nylon film, it is preferable to use UV cure adhesives such as acrylic adhesives and methacrylic adhesives; and heat-hardening (cure) adhesives such as urethane adhesives (isocyanate adhesives) and epoxy adhesives. Among them, heat-hardening adhesives are more preferable as adhesives forming an adhesive layer which exists on at least one side (preferably both sides) of the oriented nylon film. In addition, an ink layer may be set on the adhesive coating surface of a polyester film in order to indicate the ingredients or the trade name.

As for adhesives used for bonding a nylon film to a metal foil or a metal film, those described as the adhesives used for bonding a polyester film and an oriented nylon film can be used.

The methods for producing a metal laminated film used for a retort pouch of the present invention are not particularly limited, and such film can be produced by ordinary laminating methods used for producing a retort pouch, such as dry-laminating, by laminating constituent films in any order. The following production method is particularly preferable.

As the first multilayer film, three film layers are produced in accordance with the method described in Japanese Patent Publication (JP Kokoku) No. Hei 1-54191, consisting of a crystalline polypropylene resin film, an adhesive resin layer including a modified polypropylene, and a metal foil.

As the second multilayer film, the film is produced by dry-laminating, consisting the step of bonding the polyester film to an oriented nylon film through an adhesive layer

Then, the nylon film of the second multilayer film are bonded to the metal foil of the first multilayer film by using an adhesive(s) in accordance with dry-laminating.

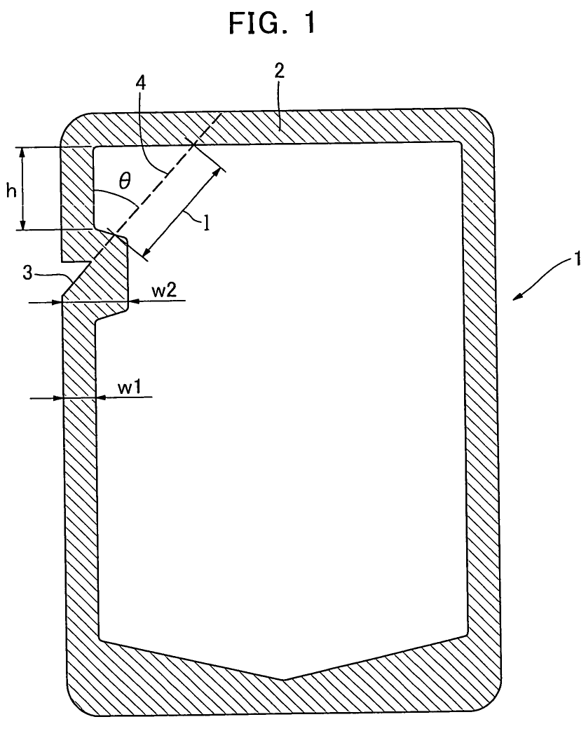

The metal laminated film thus produced can be used for producing a retort pouch. Especially, it is preferable to form a retort pouch by heat-sealing the films so that the crystalline polypropylene resin film becomes inside of the pouch. Retort pouches include standing pouches, flat pouches, and the like, and the above method is suitable for producing standing pouches. Such retort pouches include that described in FIG. 1. As indicated herein, a cutout (e.g. a notch) 3 for opening the pouch is usually set to a part 2 wherein two metal laminated films are heat-sealed, on the upper position of the side border of a package body (pouch) 1 leaving some space from the superior border thereof. In pouches of the present invention, the form of the cutout for opening (e.g. the form of the notch) can be optional, as far as it is convenient in opening. Its form may be not only a cutout form but also a simple check form. In such pouches, an opening for ejecting contents can be formed by tearing the pouch by hands along the dotted line 4 in an oblique direction. At this time, the degree θ of the dotted line 4 from the side border is preferably 20 to 80 degree and more preferably 40 to 60 degree.

Meanwhile, it is preferable that the position, degree, etc. of the cutout (e.g. notch) form for opening are set so that the length l of the opening becomes about 15 to 60 mm.

Further, regarding a heat-sealed part of the side border, the width w1, which is a lower part from the cutout for opening, is preferably within the range of 4 to 12 mm. For, such range makes breakage of the package difficult and the possible quantity to be charged in the pouch appropriate. The width w2 of the side border including the cutout for opening is preferably within the range of 8 to 16 mm. For, such range makes breakage of the package difficult and the possible quantity to be charged in the pouch appropriate. The width of the heat-sealed part inward the cutout for opening is preferably 2 mm or more. For, breakage of the package does not easily happen when it is wider than 2 mm. Further, the value of (w2−w1) is preferably 4 to 12 mm and more preferably 4 to 8 mm.

In a heat-sealed part of the side border which is located superior to the cutout for opening, the length h wherein the width of the side border is narrower than w2 and extends to the superior border is preferably within the range of 10 to 25 mm. The stress concentration can be prevented when making the length h 10 mm or more, and the position of the cutout for opening is appropriate from the superior border of the pouch when making the length h 25 mm or less and, therefore, ease of opening is improved.

The above structure not only prevents the breakage of the package and improves the easiness of opening, but also provides the effect that spilling and splash of the liquid do not occur because the flow of the contents does not roil when transferring the contents to a cup and the like due to the unique seal form of the embodiment of the present invention and, therefore, the pouring ability is improved.

According to the present invention, there can be provided retort pouches of which opening is easily formed by tearing a check in an oblique direction and from which the contents such as retort foods and liquid diets are easily transferred to other containers. Besides, benefits are obtained such as that the holes are not easily made on the side of the containers because the pouches of the present invention are not easily torn or damaged on the parts other than a cutout (e.g. notch) for opening.

Examples will further illustrate the present invention.

### EXAMPLE 1

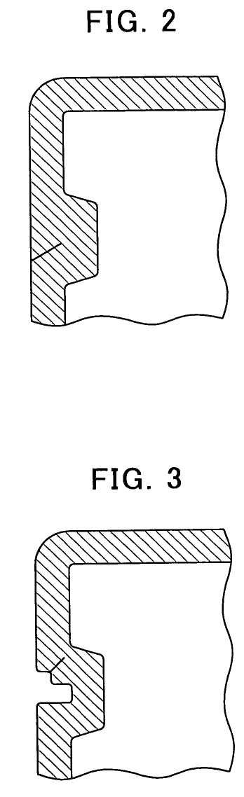

An oriented nylon film and a polyester film were laminated by dry-laminating on a four layer film produced by the method described in Japanese Patent Publication (JP Kokoku) No. Hei 1-54191, that is, an aluminum foil/a maleic anhydride modified polypropylene resin layer/an unmodified polypropylene resin layer/an ethylene propylene block copolymer in order to produce a metal laminated film consisting of a polyester film (thickness: 12 μm)/an urethane heat-hardening adhesive layer/an oriented nylon film (thickness: 15 μm)/an urethane heat-hardening adhesive layer/an aluminum foil (thickness: 7 μm)/a maleic anhydride modified polypropylene resin layer (thickness: 3 μm)/an unmodified polypropylene resin layer (thickness: 12 μm)/an ethylene propylene block copolymer (thickness: 60 μm). This metal laminated film was heat-sealed by its edges so that the ethylene propylene block copolymer became inside to produce a standing retort pouch 1 of FIG. 1. FIG. 1 shows a front view of the pouch, wherein the shaded area 2 indicates heat-sealed part and the cutout (the notch) 3 for opening is set obliquely to the upper position of the side border of the pouch (Sample 1). Further, Sample 2 (FIG. 2) and Sample 3 (FIG. 3) were produced, wherein the shape of the cutout (the notch) 3 for opening was different.

### EXAMPLE 2

Using a metal laminated film laminated by dry-laminating, consisting of a polyester film (thickness: 12 μm)/an urethane heat-hardening adhesive layer/an oriented nylon film (thickness: 15 μm)/an urethane heat-hardening adhesive layer/an aluminum foil (thickness: 7 μm)/an urethane heat-hardening adhesive layer/an ethylene propylene block copolymer (thickness: 60 μm), the film was heat-sealed by its edges so that the ethylene propylene block copolymer became inside to produce Samples 4, 5 and 6, each of which had the same shape of the cutout (the notch) 3 for opening as that of Samples 1, 2 and 3, respectively.

### EXAMPLE 3

### Sensory Evaluation

The sensory evaluation was conducted (5 panelists) on ease of obliquely opening and pouring ability into a cup using the standing retort pouches produced by Examples 1 and 2. The index of the ease of obliquely opening was based on extremely hard to open (−2), usual (0), and extremely easy to open (2). The index of the pouring ability into a cup was based on extremely hard to pour (−2), usual (0), and extremely easy to pour (2). Each were evaluated by 5 scale evaluation (−2, −1, 0, 1, 2).

The ease of obliquely opening of Sample 1 (0.7), Sample 2 (0.4) and Sample 3 (0.8) in Example 1 were better than that of Sample 4 (−1.6), Sample 5 (−1.5) and Sample 6 (−1.8) in Example 2.

The pouring ability into a cup of Sample 1 (0.7), Sample 2 (0.3) and Sample 3 (0.9) in Example 1 were better than that of Sample 4 (−0.6), Sample 5 (−0.4) and Sample 6 (−0.6) in Example 2. As a result of measuring the width of the opening of Samples 3 and 6, each averages (n=10) were 3.3 mm and 1.0 mm, respectively. Thus, it is thought that the pouring ability was improved because difference of the metal laminated film stabilized the transversal extension ability of the opening.

Further, when the length of the opening of Sample 3, which was evaluated as easiest to pour, was measured, it was 50 mm at maximum, 20 mm at minimum, and 33.2 mm in average.

### EXAMPLE 4

As for the pouch of Sample 3, those wherein the length h of the heat-sealed part extending to the side border of the upper part from the cutout for opening is 8 mm (Sample 7) and 16 mm (Sample 8) were produced and their strength against fall was examined.

After leaving them under the environments of ordinary temperature (20° C., 60% RH) and low temperature (−5° C.) for 24 hours, a case (n=6 cases, 24 samples/case) with the sample in it was tested by being dropped by a drop tester. One corner, three edges, and two faces thereof were dropped from the height of 40 cm each one time, and the bottom face was dropped from the height of 40 cm one time. Then, the inside of the pouch was checked and the number of the pouches which were torn by its edges or damaged was counted.

As a result, there was no damaged package in each case. However, number of the packages of which edges were torn was 4.2% (Sample 7) and 0% (Sample 8) at ordinary temperature, and 9.7% (Sample 7) and 0.7% (Sample 8) at low temperature.

What is claimed is:

1. A retort pouch which is made from a metal laminated film having the multilayer structure of a crystalline polypropylene resin film/an adhesive resin layer including a modified polypropylene/a metal foil/an adhesive layer/an oriented nylon film/an adhesive layer/a polyester film.

2. The retort pouch according to claim. 1, wherein the modified polypropylene is a carboxylic acid modified polypropylene.

3. The retort pouch according to claim 1, wherein the adhesive resin layer including a modified polypropylene is in a double layer form consisting of the modified polypropylene resin layer and the unmodified polypropylene resin layer, and the modified polypropylene resin layer adheres to the metal foil.

4. The retort pouch according to claim 1, wherein the metal foil is an aluminum foil.

5. The retort pouch according to claim 1, wherein an adhesive forming an adhesive layer which exists on at least one side of the oriented nylon film is a heat-hardening adhesive.

6. The retort pouch according to claim. 1, wherein the thickness of the crystalline polypropylene resin film is 30 to 80 μm; that of the metal foil is 3 to 10 μm; that of the oriented nylon film is 10 to 30 μm; and that of the polyester film is 9 to 20 μm.

7. The retort pouch according to claim 1, which is formed by heat-sealing the metal laminated film so that the crystalline polypropylene resin film becomes inside of the pouch.

8. The retort pouch according to claim 1, which is a standing pouch.

9. A retort pouch wherein a cutout for opening that is opening toward the side border is formed on the upper position of a heat-sealed part leaving some space from the superior border, and an opening for pouring the contents is formed on the cut part by cutting the corner between the cutout and the superior border; and the opening is formed by cutting the corner along the line extending from the cutout for opening to the superior border at angles of 20 to 80 degrees to the side border.

10. The retort pouch according to claim 9, which is formed by a metal laminated film having the multilayer structure of a crystalline polypropylene resin film/an adhesive resin layer including a modified polypropylene/a metal foil/an adhesive layer/an oriented nylon film/an adhesive layer/a polyester film.

11. The retort pouch according to claim 10, wherein the modified polypropylene is a carboxylic acid modified polypropylene.

12. The retort pouch according to claim 10, wherein the adhesive resin layer including a modified polypropylene is in a double layer form consisting of the modified polypropylene resin layer and the unmodified polypropylene resin layer, and the modified polypropylene resin layer adheres to the metal foil.

13. The retort pouch according to claim 10, wherein the metal foil is an aluminum foil.

14. The retort pouch according to claim 10, wherein an adhesive forming an adhesive layer which exists on both sides of the oriented nylon film is a heat-hardening adhesive.

15. The retort pouch according to claim 9, wherein the length of the opening formed by the cutting is set to 15 to 60 mm.

16. The retort pouch according to claim 9, wherein the length of the heat-sealed part of the side border which is located superior to the cutout for opening is within the range of 10 to 25 mm.

17. The retort pouch according to claim 9; which is a standing pouch.
